(19) United States
(12) Patent Application Publication
(10) Pub. No.: US 2004/0179750 A1
(43) Pub. Date: Sep. 16, 2004

(54) Image processing apparatus, image processing method and image processing program for magnifying an image

(76) Inventor: Takeshi Kumakura, Shiki-gun (JP)

Correspondence Address: HARNESS, DICKEY & PIERCE, P.L.C., P.O. BOX 8910, RESTON, VA, 20195, US

(21) Appl. No.: 10/681,314

(22) Filed: Oct. 9, 2003

(30) Foreign Application Priority Data
Sep. 10, 2002 (JP) P2002-296072

(51) Int. Cl. G06K 9/36; G06K 9/40

(52) U.S. Cl. 382/291; 382/260

(57) ABSTRACT

A differentiability judgment portion (2) judges differentiability of patterns in an original image, based on human vision characteristics. Based on the results of this judgment, a magnification processing portion (3) selects a magnified image generated by a spatial frequency preserving image magnification portion (30) for patterns in the original image whose differentiability has been judged to be low, and selects a magnified image generated by an edge emphasizing image magnification portion (31) for patterns whose differentiability has been judged to be high, and obtaining a magnified image of the entire original image by combining the selected magnified images. Thus, when magnifying the original image, a magnifying process is performed, in which patterns that are difficult to differentiate and are non-conspicuous with regard to human vision characteristics stay non-conspicuous, whereas patterns that are easy to differentiate and are conspicuous are subjected to a magnification process that emphasizes edges.

### BACKGROUND OF THE INVENTION

1. Field of the Invention

The present invention relates to image processing apparatus and image processing methods for magnifying images, and more specifically to image processing apparatus or the like for generating an image to be displayed by a display device or to be output by a printer by magnifying an original image.

2. Description of the Related Art

Image magnification increases the number of pixels compared to an original image, so that there are interpolation techniques for deciding the values of those newly added pixels. Widely used techniques for magnifying digital images include (see for example Mikio Takagi, “Image Analysis Handbook,” University of Tokyo Press, Jan. 17, 1991, p. 441-p. 444):

(1) the nearest neighbor interpolation method;

(2) the bilinear interpolation method; and

(3) the cubic convolution interpolation method.

As shown in FIG. 17, the nearest neighbor interpolation method uses the value of the pixel P_{i,j+1} that is at the position closest to the interpolated pixel P(u,v) that has been newly added due to the magnification directly as the brightness value of that interpolated pixel P(u,v). With this method, the contrast after the magnification is still high, and since it is the simplest method, processing at high speeds is possible, but slanted lines tend to be jaggy, and the image quality is extremely poor.

According to the bilinear interpolation method, a planar interpolation is performed using the values of the four pixels P_{i,j}, P_{i,j+1}, P_{i+1,j}, and P_{i+1,j+1} surrounding the interpolated pixel P(u,v), as shown in FIG. 18. With this approach, there is no jaggedness as in the nearest neighbor method, and an effect of smoothing of the image can be attained, but there is the disadvantage that portions at which the density changes abruptly, such as edges, become fuzzy.

According to the cubic convolution interpolation method, a curved interpolation according to a cubic function is performed using the sixteen pixels P_{1,1} to P_{4,4} surrounding the interpolated pixel P(u,v), as shown in FIG. 19. With this approach, an edge-emphasizing effect can be attained, and the image does not becomes as fuzzy as with the bilinear method, but the calculation amount is large, and the image tends to quiver slightly.

It should be noted that the magnification of a digital image is equivalent to reducing the sampling interval, and higher frequency components can be reproduced in accordance with the resulting higher resolution. However, with the above-noted methods, the frequency components of the magnified images are the same as the frequency components of the original image before the magnification, so that there is the problem that the image looks fuzzy to the extent that the image size has been enlarged.

In order to address these problems, Japanese Non-examined Patent Publication No. Hei. 04-330858 discloses an image magnification method with which the fuzziness of the image can be eliminated by compensating those high frequency components through an interpolation using a filter emphasizing high frequency components and a cubic B-spline function.

Furthermore, Japanese Non-examined Patent Publication No. Hei 04-333989 discloses an image magnification apparatus for processing images by conversion in the frequency domain, in which original image data that has been partitioned into blocks of predetermined size is subjected to an orthogonal transform to convert the frequency components, “0” data is added to the high-frequency component region, and an inverse orthogonal transform is carried out, thereby obtaining a magnified image.

Furthermore, in Japanese Non-examined Patent Publication No. Hei 07-152907, an image magnification method and apparatus utilizing the frequency domain are disclosed, that anticipatorily compensate high frequency components by an orthogonal wavelet transform, obtaining the magnified image by forming an inverse transform.

In the conventional technology described above, it is common to avoid jaggedness or fuzziness of edges and distortions in the magnified image by emphasizing, adding or compensating high-frequency components.

However, with these conventional image magnification approaches, non-conspicuous noise and small patterns that are included in the original image before magnification are faithfully magnified as well and become conspicuous. For example, FIG. 20A shows an example in which fine noise that is initially non-conspicuous is magnified vertically and horizontally by two, thus becoming a noise pattern that is conspicuous and offensive to the eye. Furthermore, FIG. 20B shows an example in which initially non-conspicuous noise running in a slanted direction is magnified vertically and horizontally by two, thus becoming a noise pattern that is conspicuous and offensive to the eye. FIG. 20C shows an example in which a pattern that is initially non-conspicuous is magnified vertically and horizontally by two, and the texture of the original pattern is lost.

Thus, with conventional image magnification methods, there is the problem that image patterns that should be invisible after magnification become visible, and the apparent image quality deteriorates.

Furthermore, other reasons why patterns may become conspicuous are not only that the patterns of the original image become large due to the magnification, but also that in digital images, resolution is expressed in integer multiples of pixels, so that gradation values are interpolated by making the pixels lighter or darker, and the surface area tends to become larger than the original surface area to be magnified. This is illustrated in FIGS. 21A and 21B, which show an example in which one pixel is magnified laterally by 1.5. FIG. 21A schematically shows the density of a pixel, and FIG. 21B shows the density of the pixel by vertical amplitude. For an analog image, a magnification of precisely 1.5 can be attained by magnifying the image to the position indicated by the dotted line in FIG. 21B. However, for digital images, the image is actually magnified to the position of a magnification by two, and the density is interpolated as indicated by the solid lines in FIG. 21B, so that the sum of the apparent densities of the magnification by 1.5 becomes the same as for the case of a magnification of an analog image.

Moreover, the improvement of the fuzziness of edges by conventional technology tends to attain the result that noise and patterns that are non-conspicuous are further emphasized.

Compared to the problems addressed by the conventional technology, namely the occurrence of jaggedness or fuzziness of edges when magnifying, the above-noted problems are considered little and hardly improved at all.

### SUMMARY OF THE INVENTION

It is thus an object of the present invention to provide an image processing apparatus and an image processing method that magnify an image such that non-conspicuous noise or patterns that are included in the original image before magnification are non-conspicuous after the magnification as well.

According to a first aspect of the present invention, an image processing apparatus for magnifying an image includes:

a differentiability judgment portion for judging differentiability in an original image to be magnified, based on human vision characteristics; and

a magnification processing portion for generating a magnified image of the original image by magnifying the original image in a manner that is adapted to the differentiability judged by the differentiability judgment portion.

With this configuration, the original image is magnified in a manner that is adapted to the differentiability based on human vision characteristics (for example with an image magnification approach that is adapted to differentiability), so that non-conspicuous patterns that are difficult to differentiate for humans are subjected to a magnification process in which they stay non-conspicuous, and a deterioration of the image quality that occurs when noise or patterns that are difficult to differentiate before the magnification are magnified can be avoided.

In this image processing apparatus, it is preferable that:

the differentiability judgment portion judges the differentiability based on gradation characteristics of human vision.

With this configuration, a deterioration of the image quality that occurs when noise or patterns that are difficult to differentiate before the magnification are magnified can be avoided by judging the differentiability in the original image on the basis of gradation characteristics of vision according to which the number of gradations that can be differentiated decreases when the spatial frequency of the image becomes high, and by magnifying the original image in a manner that is adapted to this differentiability.

In this image processing apparatus, it is preferable that the differentiability judgment portion includes:

a decomposing portion for decomposing the original image into a plurality of constituent images, based on spatial frequency; and

a threshold processing portion for determining the differentiability of each of the constituent images by classifying the plurality of constituent images with a predetermined threshold based on human vision characteristics;

wherein the magnification processing portion magnifies the constituent images obtained with the decomposing portion in a manner that is adapted to the differentiability determined by the threshold processing portion for each of the constituent images, and generates a magnified image of the original image by combining the magnified constituent images.

With this configuration, the original image is decomposed into a plurality of constituent images based on spatial frequency, the differentiability of each of the constituent images is judged based on human vision characteristics, and a magnified image of the original image is generated by combining the constituent images after they have been magnified in a manner that is adapted to their respective differentiability. Thus, a deterioration of the image quality that occurs when noise or patterns that are difficult to differentiate before the magnification are magnified can be avoided.

In this image processing apparatus, it is preferable that the differentiability judgment portion includes:

a filter portion having filter characteristics approximating human vision characteristics;

a differential generating portion for generating a differential between the original image and the image obtained by passing the original image through the filter portion; and

a differentiability determining portion for determining the differentiability in the original image based on this differential.

With this configuration, the differentiability in the original image is determined based on a differential between the original image and the image obtained by passing the original image through a filter portion having filter characteristics approximating human vision characteristics, and the original image is magnified in a manner that is adapted to this differentiability. Thus, a deterioration of the image quality that occurs when noise or patterns that are difficult to differentiate before the magnification are magnified can be avoided.

In this image processing apparatus, it is preferable that the magnification processing portion comprises:

a plurality of image magnification portions for performing different types of image magnification processes on the original image; and

a selection portion for selecting from the plurality of image magnification portions the image magnification portion that is to generate the magnified image of the original image in accordance with the differentiability judged by the differentiability judgment portion.

With this configuration, the original image is magnified in a manner that is adapted to the differentiability according to human vision characteristics by selecting, from a plurality of image magnification portions, the image magnification portion to generate the magnified image of the original image, in accordance with the differentiability judged by the differentiability judgment portion. Thus, a deterioration of the image quality that occurs when noise or patterns that are difficult to differentiate before the magnification are magnified can be avoided.

In this image processing apparatus, it is preferable that:

the differentiability judgment portion judges whether the differentiability in the original image is high or low; and

wherein, if the differentiability has been judged to be low by the differentiability judgment portion, the magnification processing portion carries out the image magnification process after a filtering process with filter characteristics approximating human vision characteristics has been performed.

With this configuration, portions that have low differentiability for humans in the original image are magnified after smoothing them with a filtering process, so that patterns that are offensive to the eye do not appear due to the magnification process, and the deterioration of image quality in the magnified image of the original image can be reduced.

It is preferable that the image processing apparatus further includes:

a measuring portion for measuring a visual distance from a display surface on which the magnified image obtained by magnifying the original image with the magnification processing portion is to be displayed to a viewpoint of a person that is to view the magnified image; and

an adjusting portion for adjusting a judgment criterion of the differentiability in the differentiability judgment portion based on the visual distance.

With this configuration, the differentiability is adjusted in the same manner as the gradation characteristics of human vision, in accordance with the visual distance from a display surface on which the magnified image is to be displayed to a viewpoint of a person that is to view the magnified image, so that a magnified image can be obtained that is adapted to the present visual distance and in which there is little deterioration of image quality.

It is preferable that the image processing apparatus further includes:

a partitioning portion for partitioning the original image into a plurality of partial images; and

a control portion for causing the differentiability judgment portion to judge the differentiability of each of the partial images obtained with the partitioning portion, based on human vision characteristics, and for causing the magnification processing portion to magnify the partial images in a manner that is adapted to their respective judged differentiability.

With this configuration, the differentiability is judged, based on the human vision characteristics, for each of the partial images obtained by partitioning the original image, and the partial images are magnified in a manner that is adapted to their respective judged differentiability, so that the amount of memory and circuitry that is necessary for the image processing to magnify the original image can be reduced. Furthermore, by performing the differentiability judgment process or the image magnification process for the plurality of partial images in parallel, it is possible to shorten the processing time of the image magnification apparatus.

According to another aspect of the present invention, an image processing method for magnifying an image includes:

a differentiability judgment step of judging differentiability in an original image to be magnified, based on human vision characteristics; and

a magnification processing step of generating a magnified image of the original image by magnifying the original image in a manner that is adapted to the differentiability judged based on the human vision characteristics.

In this image processing method, it is preferable that:

in the differentiability judgment step, the differentiability is judged based on gradation characteristics of human vision.

In this image processing method, it is preferable that the differentiability judgment step includes:

a decomposition step of decomposing the original image into a plurality of constituent images, based on spatial frequency; and

a threshold processing step of determining the differentiability of each of the constituent images by classifying the plurality of constituent images with a predetermined threshold based on human vision characteristics;

wherein in the magnification processing step, the constituent images obtained in the decomposition step are magnified in a manner that is adapted to the differentiability determined by the threshold processing step for each of the constituent images, and a magnified image of the original image is generated by combining the magnified constituent images.

In this image processing method, it is preferable that the differentiability judgment step instead includes:

a differential generation step of generating a differential between the original image and the image obtained by passing the original image through a filter having filter characteristics that approximate human vision characteristics; and

a differentiability determination step of determining the differentiability in the original image based on the differential.

In this image processing method, it is preferable that the magnification processing step includes:

a selection step of selecting an image magnification process from different types of image magnification processes that have been prepared in advance, in accordance with the differentiability judged with the differentiability judgment step; and

an image magnification step of magnifying the original image with the selected image magnification process.

In this image processing method, it is preferable that:

in the differentiability judgment step, it is judged whether the differentiability in the original image is high or low; and

if the differentiability has been judged to be low in the differentiability judgment step, the image magnification process is carried out in the magnification processing step after a filtering process with filter characteristics approximating human vision characteristics has been performed.

It is preferable that this image processing method further includes:

a measurement step of measuring a visual distance from a display surface on which the magnified image obtained by magnifying the original image in the magnification processing step is to be displayed to a viewpoint of a person that is to view the magnified image; and

an adjustment step of adjusting a judgment criterion of the differentiability in the differentiability judgment step based on the visual distance.

It is preferable that this image processing method further includes:

a partition step of partitioning the original image into a plurality of partial images;

wherein in the differentiability judgment step, the differentiability of each of the partial images obtained with the partition step is judged based on human vision characteristics; and

wherein in the magnification processing step, the partial images are magnified in a manner that is adapted to their respective judged differentiability.

According to yet another aspect of the present invention, an image processing program for magnifying an image, when executed by a computer, causes the computer to perform:

a differentiability judgment step of judging differentiability in an original image to be magnified, based on human vision characteristics; and

a magnification processing step of generating a magnified image of the original image by magnifying the original image in a manner that is adapted to the differentiability judged based on the human vision characteristics.

In this image processing program, it is preferable that:

in the differentiability judgment step, the differentiability is judged based on gradation characteristics of human vision.

In this image processing program, it is preferable that the differentiability judgment step includes:

a decomposition step of decomposing the original image into a plurality of constituent images, based on spatial frequency; and

a threshold processing step of determining the differentiability of each of the constituent images by classifying the plurality of constituent images with a predetermined threshold based on human vision characteristics;

wherein in the magnification processing step, the constituent images obtained in the decomposition step are magnified in a manner that is adapted to the differentiability determined by the threshold processing step for each of the constituent images, and a magnified image of the original image is generated by combining the magnified constituent images.

In this image processing program, it is preferable that the differentiability judgment step includes:

a differential generation step of generating a differential between the original image and the image obtained by passing the original image through a filter having filter characteristics that approximate human vision characteristics; and

a differentiability determination step of determining the differentiability in the original image based on the differential.

In this image processing program, it is preferable that the magnification processing step includes:

a selection step of selecting an image magnification process from different types of image magnification processes that have been prepared in advance, in accordance with the differentiability judged with the differentiability judgment step; and

an image magnification step of magnifying the original image with the selected image magnification process.

In this image processing program, it is preferable that:

in the differentiability judgment step, it is judged whether the differentiability in the original image is high or low; and

if the differentiability has been judged to be low in the differentiability judgment step, the image magnification process is carried out in the magnification processing step after a filtering process with filter characteristics approximating human vision characteristics has been performed.

It is preferable that this image processing program further includes:

a measurement step of measuring a visual distance from a display surface on which the magnified image obtained by magnifying the original image in the magnification processing step is to be displayed to a viewpoint of a person that is to view the magnified image; and

an adjustment step of adjusting a judgment criterion of the differentiability in the differentiability judgment step based on the visual distance.

It is preferable that this image processing program further includes:

a partition step of partitioning the original image into a plurality of partial images;

wherein in the differentiability judgment step, the differentiability of each of the partial images obtained with the partition step is judged based on human vision characteristics; and

wherein in the magnification processing step, the partial images are magnified in a manner that is adapted to their respective judged differentiability.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the overall configuration of an image magnification apparatus in accordance with a first embodiment of the present invention.

FIG. 2 is a graph illustrating the gradation characteristics of vision.

FIG. 3 is a block diagram showing a first configuration example of the differentiability judgment portion in the first embodiment.

FIG. 4 is a block diagram illustrating the configuration of a two-band partitioning filter bank, which is an example of the frequency domain transformation portion in the first embodiment.

FIG. 5 is a filter characteristics graph of the two-band partitioning filter bank.

FIGS. 6A to 6D are diagrams illustrating the operation of the two-band partitioning filter bank and the threshold processing portion in the first embodiment.

FIG. 7 is a block diagram showing the configuration of an n-band partitioning filter bank, which is another example of the frequency domain transformation portion in the first embodiment.

FIG. 8 is a frequency characteristics graph illustrating the filter characteristics of the n-band partitioning filter bank.

FIG. 9 is a block diagram showing a second configuration example of the differentiability judgment portion in the first embodiment.

FIG. 10 is a block diagram showing a first configuration example of a magnification processing portion according to the first embodiment.

FIGS. 11A and 11B are diagrams illustrating the difference between the spatial frequency preserving magnification process and the edge emphasizing magnification process in the first embodiment.

FIG. 12 is a block diagram showing a second configuration example of the magnification processing portion in the first embodiment.

FIG. 13 is a block diagram illustrating the overall configuration of an image magnification apparatus in accordance with a second embodiment of the present invention

FIG. 14 is a block diagram illustrating the overall configuration of an image magnification apparatus in accordance with a third embodiment of the present invention.

FIG. 15 is a flowchart showing the procedure of the image magnification processing program in a fourth embodiment of the present invention.

FIG. 16 is a flowchart showing the procedure of the partitioned image magnification processing program in a modified example of the fourth embodiment of the present invention.

FIG. 17 is a diagram illustrating the nearest neighbor interpolation method of the conventional technology.

FIG. 18 is a diagram illustrating the bilinear interpolation method of the conventional technology.

FIG. 19 is a diagram illustrating the cubic convolution interpolation method of the conventional technology.

FIGS. 20A to 20C show examples in which an image pattern with low differentiability is magnified horizontally and vertically by two in accordance with conventional technology.

FIGS. 21A and 21B illustrate an example in which an image of one pixel is magnified horizontally by 1.5 in accordance with conventional technology.

### DESCRIPTION OF THE PREFERRED EMBODIMENTS

The following is a description of embodiments of the present invention, with reference to the accompanying drawings.

### 1. First Embodiment

1.1 Overall Configuration and Principle

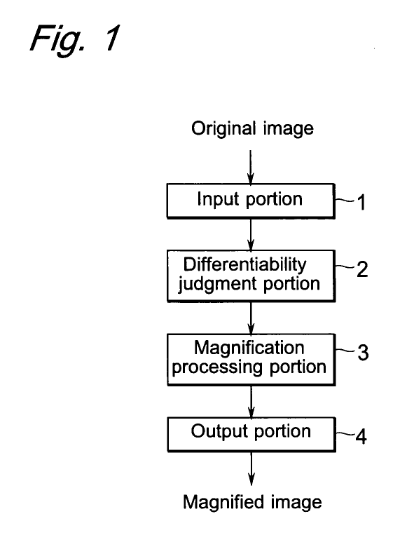

FIG. 1 is a block diagram illustrating the overall configuration of an image magnification apparatus in accordance with a first embodiment of the present invention. This image magnification apparatus is an image processing apparatus for magnifying digital images, and includes an input portion 1, a differentiability judgment portion 2, a magnification processing portion 3, and an output portion 4. A digital image is input as the original image into the input portion 1. The differentiability judgment portion 2 judges whether an image pattern region (image portion or constituent image) is not conspicuous in view of the gradation characteristics of human vision, that is, a region for which the differentiability according to human vision is low, or whether that image pattern region (image portion or constituent image) is conspicuous, that is, a region for which the differentiability is high. The magnification processing portion 3 generates a magnified image of the original image by performing a magnification process in accordance with the judgment result. The output portion 4 outputs the generated magnified image.

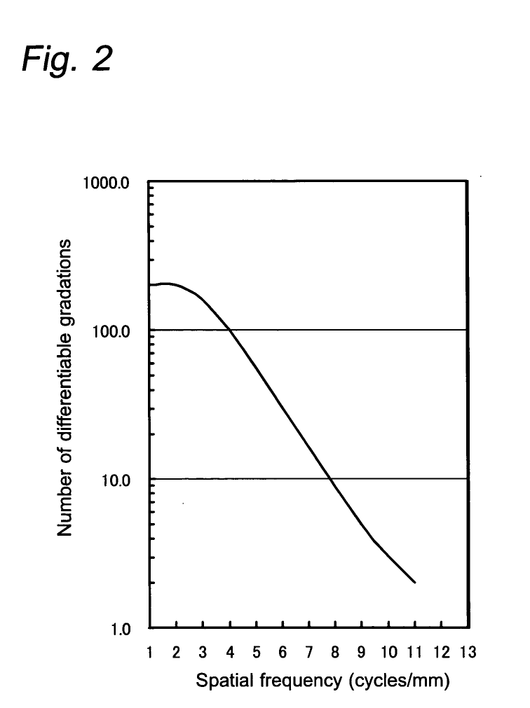

As has been disclosed elsewhere (see for example Akito Iwamoto, “Digital Hard Copy Technology,” Kyoritsu Shuppan, Nov. 15, 2000, p. 83-p. 84), human vision has the gradation characteristics as shown in FIG. 2, that is, when the spatial frequency of an image becomes high, then the number of gradations that can be differentiated decreases. Methods that utilize these gradation characteristics to realize artificial intermediate densities by varying a limited number of color densities in frequency regions that are higher than the human differentiation ability are digital half-toning techniques such as the error diffusion method and the dither method, which are used in printers and display devices for example. It should be noted that in the following, “frequency” means the spatial frequency, unless specified otherwise.

Utilizing the gradation characteristics of human vision, it is possible to judge the differentiability for patterns included in the original image to be magnified, and to distinguish between conspicuous patterns (patterns that are easy to differentiate, that is, patterns with high differentiability) and non-conspicuous patterns (patterns that are difficult to differentiate, that is, patterns with low differentiability) in the original image. If, based on the result of the judgment of the differentiation of the pattern included in the original image, patterns that are difficult to differentiate are magnified unchanged as difficult-to-differentiate patterns, and patterns that are easy to differentiate are subjected to a conventional image magnification process that emphasizes and adds or compensates high frequency components in order to reduce the jaggedness or fuzziness of edges, then it is possible to achieve a magnified image with little image deterioration, in accordance with the above-stated object of the present invention. The following is a detailed description of the various components of an image magnification apparatus in accordance with the present embodiment, based on this principle.

1.1 Input Portion

The input portion 1 in the present embodiment functions as an interface for inputting an original image to be magnified by the image magnification apparatus according to the present embodiment. This input portion 1 receives data or a signal representing an original image from the outside, and converts the data or signal into digital image data or a digital image signal of a format that is suitable for the processing inside the image magnification apparatus, and feeds the digital image data or signal to the differentiability judgment portion 2.

1.2 Differentiability Judgment Portion

1.2.1 First Configuration Example

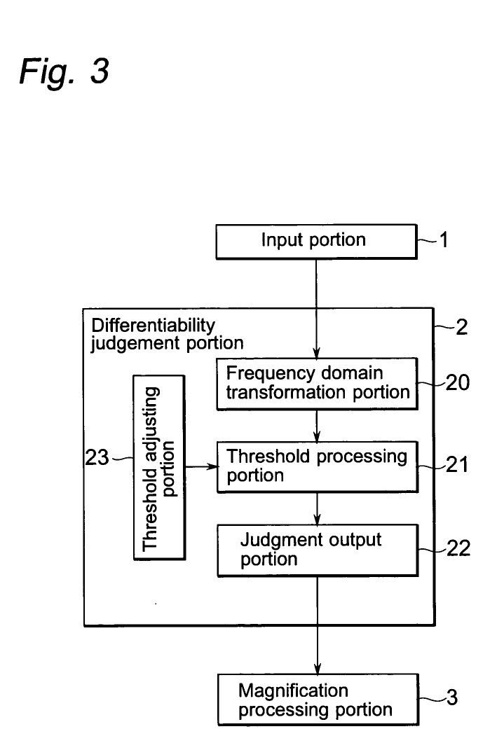

FIG. 3 is a block diagram showing a first configuration example of the differentiability judgment portion 2 in the present embodiment. The differentiability judgment portion 2 judges the differentiation of the patterns included in the original image as indicated by the image data or image signal sent from the input portion 1, and includes a frequency domain transformation portion 20, a threshold processing portion 21, a judgment output portion 22, and a threshold adjusting portion 23.

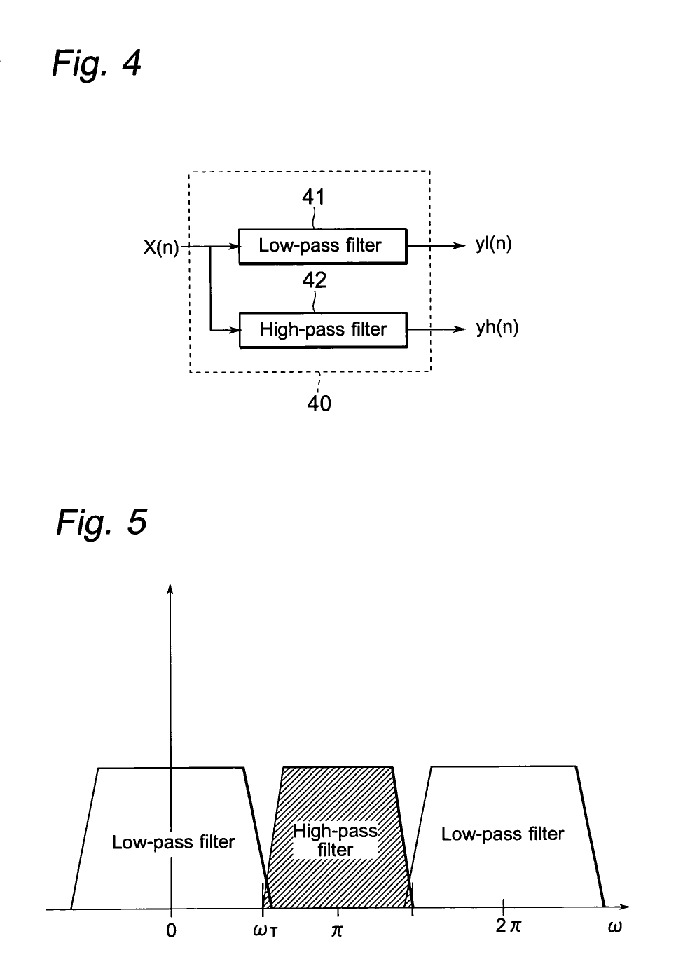

The frequency domain transformation portion 20 functions as a decomposing portion for decomposing the original image into a plurality of constituent images, by performing a transformation into the frequency domain (Fourier transform, digital cosine transform (DCT), wavelet transform or the like). In this embodiment, the original image is decomposed into a plurality of constituent images by partitioning the frequency band of the original image into a plurality of small bands, and transforming the original image into frequency components corresponding to those small bands. More specifically, a two-band partitioning filter bank 40, which is made of a low-pass filter 41 and a high-pass filter 42 as shown for example in FIG. 4, partitions the digital signal x(n) representing the original image into a digital signal yl(n) representing a constituent image corresponding to the low frequency components and a digital signal yh(n) representing a constituent image corresponding to the high frequency components. In the following, to keep explanations simple, no distinction is made between images and the signals representing those images. Consequently, with the two-band partitioning filter bank 40, the original image is partitioned into a constituent image yl(n) of low frequency components and a constituent image yh(n) of high frequency components.

FIG. 5 is a filter characteristics graph (graph illustrating the amplitude response characteristics) of the two-band partitioning filter bank 40. In this filter characteristics graph, the horizontal axis represents the angular frequency ω, and 2π represents the sampling frequency of the digital image x(n). In this case, according to the sampling theorem stating that “in order to accurately sample all frequency components included in the original signal, a sampling frequency of at least twice the original frequency is necessary, ω=π becomes the maximum frequency that can be expressed with the digital image x(n).”

As can be seen from the filter characteristics graph shown in FIG. 5, the original image is split up at the frequency ω_{T} into an image (constituent image) whose frequency components are below the frequency ω_{T} and an image (constituent image) whose frequency components are above the frequency ω_{T}. That is to say, if the filters are designed such that the frequency ω_{T} is set as the frequency threshold at which differentiation becomes difficult according to the human vision characteristics, then the image yh(n) that has been band-split by the high-pass filter 42 indicates an image pattern corresponding to the frequency region at which differentiation is difficult. It should be noted that, as shown in FIG. 5, the filter characteristics of the low-pass filter 41 and the filter characteristics of the high-pass filter 42 overlap one another such that no information loss occurs. Therefore, the two-band partitioning filter bank 40 should be designed such that the cutoff frequency of the high-pass filter 42 is set to ω_{T} and the cutoff frequency of the low-pass filter 41 is set to a frequency that is a little higher than ω_{T}.

Now, it is known that human vision has gradation characteristics in which the number of gradations that can be differentiated decreases as the spatial frequency of the image increases, as shown in FIG. 2. Conversely, if the gradation changes are strong, then a pattern is easy to differentiate, within a predetermined region, even when the spatial frequency is high. Therefore, in order to perform a differentiation judgment process that is closer to the vision characteristics, the threshold processing portion 21 in the present embodiment compares the amplitude of the image yh(n) that has been band-split by the high-pass filter 42 with a appropriate threshold Th, and pixels whose amplitude is higher than the threshold Th are judged to be conspicuous pixels (pixels that are easy to differentiate, that is, pixels with high differentiability), whereas pixels whose amplitude is lower than the threshold Th are judged to be non-conspicuous pixels (pixels that are difficult to differentiate, that is, pixels with low differentiability).

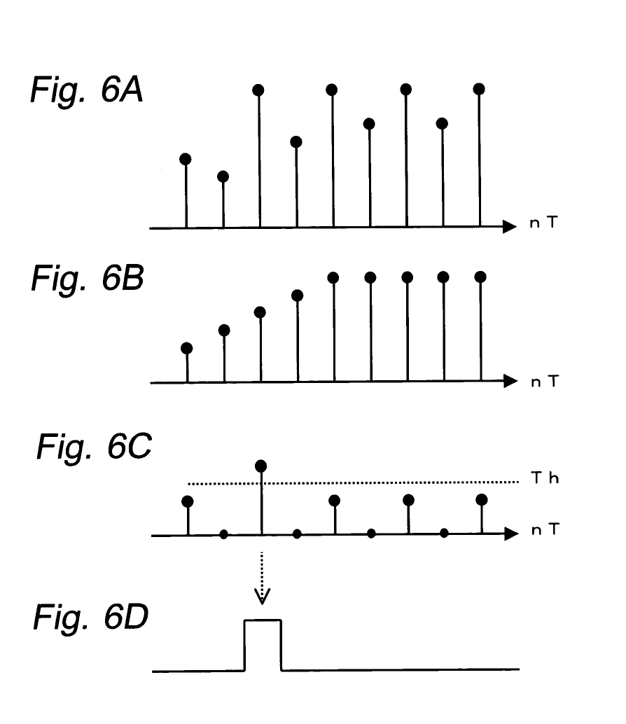

FIGS. 6A to 6D illustrate the threshold processing of the amplitude of the digital signal yh(n) of the high-frequency components that are output after band-splitting a digital image signal x(n) representing an original image with this filter bank 40. That is to say, when a digital image signal x(n) as shown in FIG. 6A is input into the filter bank 40, a digital signal yl(n) corresponding to the low frequency components as shown in FIG. 6B and a digital signal yh(n) corresponding to the high frequency components as shown in FIG. 6C are output from the filter bank 40. The threshold processing portion 21 judges that the differentiability of the pattern of the constituent image represented by the digital signal yl(n) corresponding to the low frequency components is high, but for the pattern of the constituent image represented by the digital signal yh(n) corresponding to the high frequency components, it judges a high differentiability only for the pixels whose amplitude is larger than the threshold Th, and generates a signal as shown in FIG. 6D. That is to say, the pattern of the constituent image represented by the digital signal yh(n) corresponding to the high frequency components is separated into a large-amplitude pattern made of pixels with amplitudes larger than the threshold Th and a small-amplitude pattern made of pixels with amplitudes not greater than the threshold Th. The differentiability of the large-amplitude pattern is judged to be high, and the differentiability of the small-amplitude pattern is judged to be low. It should be noted that for the sake of convenience, the digital image signals in FIGS. 6A to 6C are rendered simply with their brightness amplitudes of one-dimensional signals derived from the original image, which is the input image of this embodiment, by slicing the same.

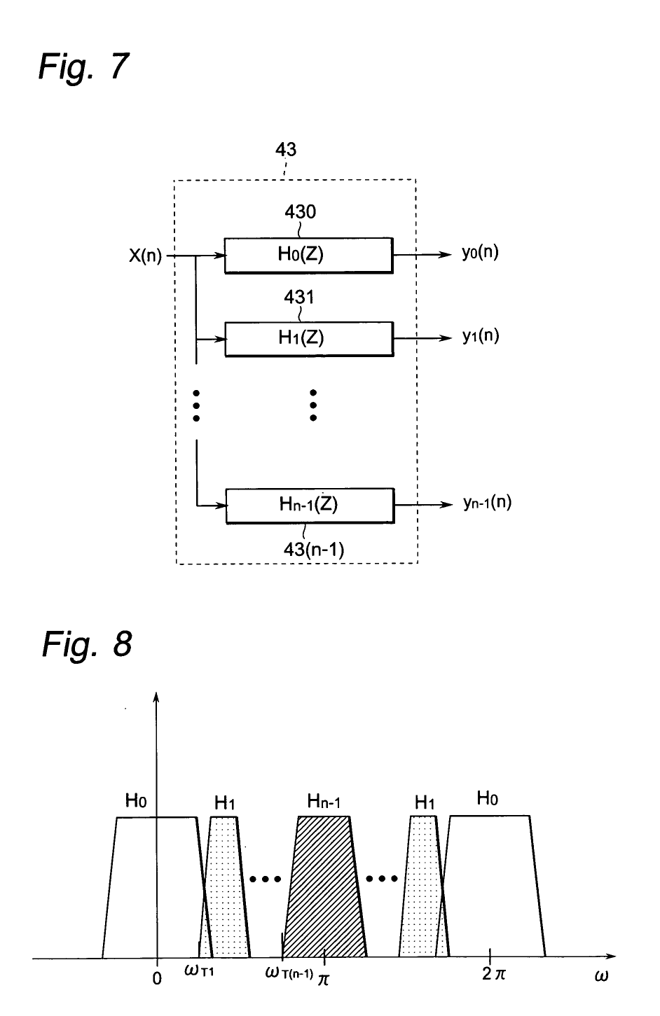

The filter bank serving as the frequency domain transformation portion 20 is not limited to the two-band partitioning filter bank 40 shown in FIG. 4. FIG. 7 is a block diagram showing another configuration of the filter bank serving as the frequency domain transformation portion 20. In this configuration example, the frequency domain transformation portion 20 is realized as an n-band partitioning filter bank 43 made of n band-pass filters 430, 431, . . . , 43(n−1). In FIG. 7, H denotes the transfer functions of the filters, that is, H₀ denotes the transfer function of the filter 430 on the low frequency side, and Hₙ₋₁ denotes the transfer function of the filter 43(n−1) on the high frequency side. FIG. 8 is a filter characteristics graph (graph illustrating the amplitude response characteristics) of this n-band partitioning filter bank 43. In this configuration example, the candidates of the frequency threshold value are given by ω_{T1} to ω_{T(n-1)}, as shown in FIG. 8, and in response to external requests to change the threshold value, it is possible to select any of the frequency threshold candidates ω_{T1} to ω_{T(n-1)} as the frequency threshold without redesigning the filter. That is to say, the frequency threshold can be switched among n frequency threshold candidates, and thus, it is possible to change the criterion for classifying the n constituent images corresponding to n frequency components into a group with high differentiability and a group with low differentiability, or in other words, to change the criterion of the differentiability judgment. Moreover, by setting the amplitude threshold individually for each of the filters 430, 431, . . . , 43(n−1), it is possible to model the vision characteristics with more detail.

The threshold adjusting portion 23 adjusts the threshold Th based on an external instruction or control signal, such that the differentiability for the patterns included in the original image is judged accurately. For example, if the original image to be magnified is a moving image, then it is preferable that the threshold Th of the amplitude is set to a larger value than if the original image is a still image. It is also possible to adjust the threshold Th in accordance with the surrounding environment in which the magnified image is displayed or output, or in accordance with the type of the original image or the like. Furthermore, if the frequency domain transformation portion 20 is realized as an n-band partitioning filter bank 43 as shown in FIG. 7, then it is also possible to switch the criterion of the differentiability judgment by selecting one of the frequency threshold candidates ω_{T1} to ω_{T(n-1)} as the frequency threshold, instead of or in addition to adjusting the threshold Th with the threshold adjusting portion 23. In this case, if for example the frequency threshold ω_{Tk} has been selected (with 0≦k≦n−1), then the patterns of the constituent images represented by the digital signals y₀(n) to yₖ(n) output from the filters 430 to 43(k) will be judged to have high differentiability. It should be noted that if the original image to be magnified is a moving image, then it is preferable to select a frequency threshold that is smaller than that for a still image.

Based on the processing result according to the threshold processing portion 21 as described above, the judgment output portion 22 outputs the judgment result regarding the differentiability of the patterns included in the original image to be magnified. For example, if the original image corresponding to the signal shown in FIG. 6A is input into the differentiability judgment portion 2, then the pattern of the constituent image represented by the digital signal yl(n) corresponding to the low frequency components shown in FIG. 6B and the image pattern represented by the signal shown in FIG. 6D are judged to have high differentiability, whereas the pattern of the constituent image represented by the digital signal yh(n) corresponding to the high frequency components shown in FIG. 6C, except for the image pattern represented by the signal shown in FIG. 6D, is judged to have low differentiability.

1.2.2 Second Configuration Example

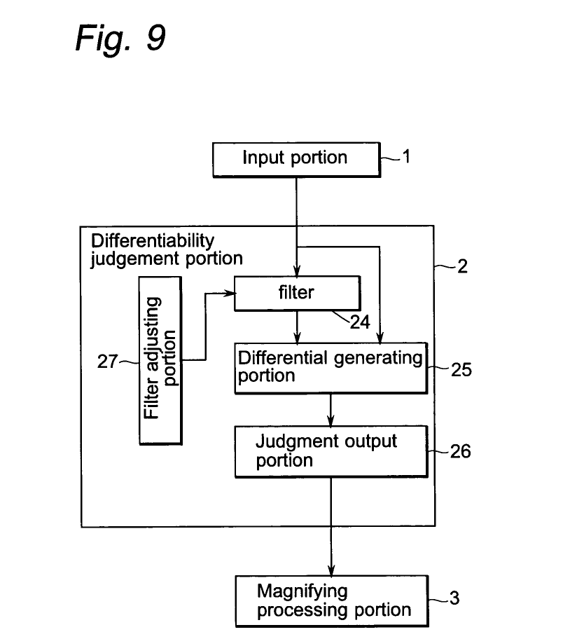

FIG. 9 is a block diagram showing a second configuration example of the differentiability judgment portion 2 according to the present embodiment. The differentiability judgment portion 2 in this configuration example includes a filter 24, a differential generating portion 25, a judgment output portion 26, and a filter adjusting portion 27. The characteristics of the filter 24 approximate human vision characteristics. The differential generating portion 25 generates differentials between the original image and images that have passed through the filter 24. The judgment output portion 26 outputs the result of a judgment of differentiability of patterns in the original image, based on the generated differential. The filter adjusting portion 27 adjusts the filter characteristics of the filter 24.

The filter 24 in this configuration has filter characteristics that approximate human vision characteristics (including frequency characteristics). For this reason, in the original image that has passed through the filter 24 (in the following, this is referred to as “filtered original image”), those frequency components in the original image that has not yet passed through the filter 24 (in the following, this is referred to as “unfiltered original image”) that are difficult to differentiate visually has been attenuated in accordance with the visual gradation characteristics shown in FIG. 2. Consequently, by taking the difference between the filtered original image and the unfiltered original image, it is possible to obtain for every position in the original image a differential amount that quantitatively indicates the degree of the difficulty of visual differentiation. Regions in which the original image is easy to differentiate (regions with high differentiability) and regions in which the original image is difficult to differentiate (regions with low differentiability) can be distinguished with the values of this differential amount. Based on the differential amount at each position in the original image output from the differential generating portion 25, the judgment output portion 26 outputs the result of the judgment regarding the differentiability of the patterns (regions) included in the original image. Consequently, the judgment output portion 26 can be said to be a differentiability determining portion for determining the differentiability in the original image. As a specific configuration, it is possible to set in advance a threshold Dth for the differential amount output from the differential generating portion 25, and when judging the differentiability of the patterns in the original image, based on this differential amount, the judgment result that the differentiability is low may be output for the regions in the original image in which the differential amount is larger than the threshold Dth and the judgment result that the differentiability is high may be output for the regions in the original image in which the differential amount is not greater than the threshold Dth.

The filter adjusting portion 27 adjusts the filter characteristics of the filter 24 by changing the coefficients of the filter 24 in accordance with an external instruction or control signal. For example, by adjusting the filter characteristics depending on whether the original image to be magnified is a moving image or a still image, or by adjusting the filter characteristics in accordance with the surrounding environment in which the magnified image is displayed or output or in accordance with the type of the original image or the like, it is possible to set filter characteristics that are well suited for persons viewing the magnified image.

It should be noted that in configurations in which the judgment result for the differentiability in the original image is determined depending on whether the differential amount from the differential generating portion 25 is larger than the threshold Dth, as described above, it is preferable to provide a threshold adjusting portion for adjusting this threshold Dth to set a threshold Dth that is suitable for this differential amount.

1.3 Magnification Processing Portion

1.3.1 First Configuration Example

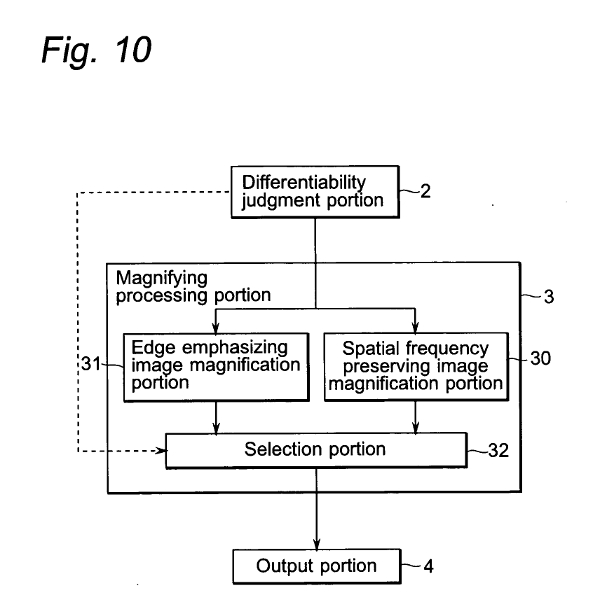

FIG. 10 is a block diagram showing a first configuration example of a magnification processing portion 3 according to the present embodiment. This magnification processing portion 3 includes a spatial frequency preserving image magnification portion 30, an edge emphasizing image magnification portion 31, and a selection portion 32. The spatial frequency preserving image magnification portion 30 magnifies the original image while preserving the spatial frequency of the original image. The edge emphasizing image magnification portion 31 emphasizes edges in the original image when magnifying images. The selection portion 32 selects the image that is to constitute the magnified image of the original image from the magnified images obtained with the spatial frequency preserving image magnification portion 30 and the edge emphasizing image magnification portion 31.

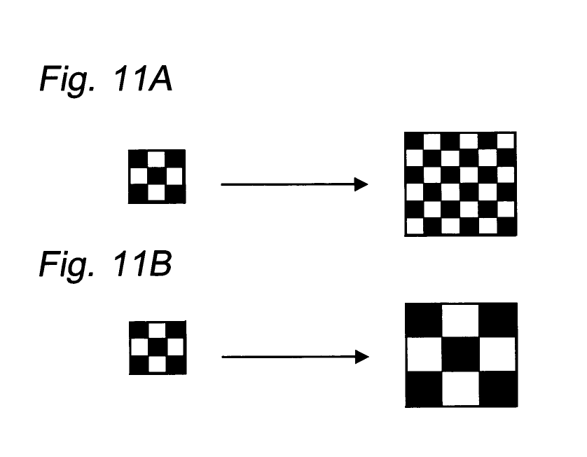

The selection portion 32 in this configuration selects the magnified image obtained with the spatial frequency preserving image magnification portion 30 for constituent images (frequency components) or patterns (regions) in the original image that have been judged by the differentiability judgment portion 2, which is arranged in the stage prior to the magnification processing portion 3, to be difficult to differentiate (to have low differentiability) in the original image, and selects the magnified image obtained with the edge emphasizing image magnification portion 31 for constituent images (frequency components) or patterns (regions) that have been judged by the differentiability judgment portion 2 to be easy to differentiate (to have high differentiability) in the original image. Consequently, for constituent images (frequency components) or patterns (regions) that have been judged to be difficult to differentiate in the original image, magnification is performed while preserving the spatial frequency, as shown in FIG. 11A, so that they can be put into a state in which they are difficult to differentiate after the magnification as well. Moreover, for constituent images (frequency components) or patterns (regions) that have been judged to be easy to differentiate in the original image, a magnified image can be obtained in which fuzziness at the edges is improved by emphasizing edges when magnifying the image as shown in FIG. 11B. The output portion 4 receives the magnified images that have been selected in this manner (i.e. the magnified images of the constituent images (frequency components) or the patterns (regions) included in the original image) from the spatial frequency preserving image magnification portion 30 and the edge emphasizing image magnification portion 31, and outputs a magnified image of the entire original image by combining (adding up) the received magnified images.

By selecting the manner of image magnification (that is, the method of image magnification processing in this example) in accordance with the judgment result for the differentiability as described above, it is possible to attain a magnified image with little deterioration in image quality as the magnified image of the original image. It should be noted that here, as a method for magnifying image patterns that have been judged to be easy to differentiated, an approach improving the jaggedness and fuzziness of edges has been used, but the present invention is not limited to any particular processing method for this.

1.3.2 Second Configuration Example

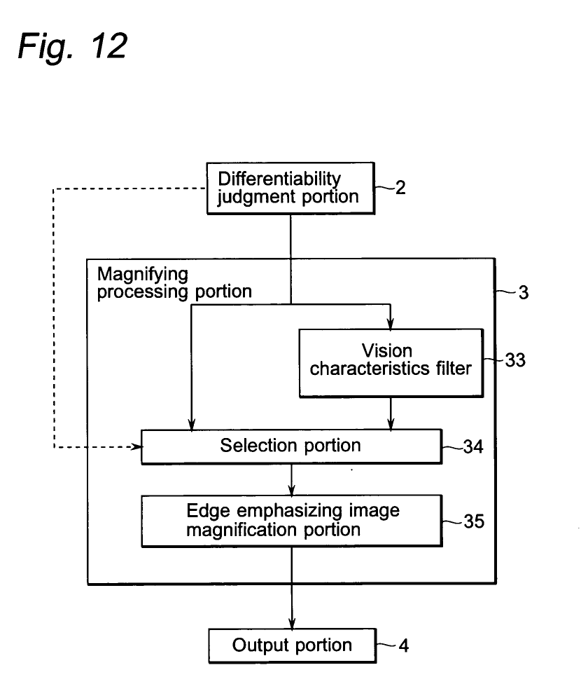

FIG. 12 is a block diagram showing a second configuration example of a magnification processing portion 3 according to the present embodiment. This magnification processing portion 3 includes a filter 33, a selection portion 34, and an edge emphasizing image magnification portion 35. The filter 33 has filter characteristics approximating the frequency characteristics of human vision (and is referred to as a “vision characteristics filter” in the following. The selection portion 34 selects either the original image or the image obtained by passing the original image through the vision characteristics filter 33 (referred to as “filtered image” in the following). The edge emphasizing image magnification portion 35 magnifies the selected image under emphasis of edges.

If the differentiability judgment portion 2 of the stage prior to the magnification processing portion 3 has judged that differentiating is difficult (differentiability is low), then the selection portion 34 in the above-noted configuration selects the image portion of the filtered image corresponding to the image portion that is the pattern or region that has been judged to have low differentiability, and if the differentiability judgment portion 2 has judged that differentiating is easy (differentiability is high), then the selection portion 34 selects the image portion in the original image that is the pattern or region that has been judged to have high differentiability. A magnified image of the original image is obtained by performing an image magnification with the edge emphasizing image magnification portion 35 emphasizing the edges in the image made of the thus selected image portions.

With this configuration, the frequency components that are difficult to visually differentiate in the filtered image, which is the image that has passed through the vision characteristics filter 33, are attenuated, so that the image is smoothened in the regions of the original image that are difficult to differentiate. Then, the density values of the smoothened regions become the same as the density values in the original image when observed with human vision. Thus, patterns or regions that have been judged to be difficult to differentiate in the original image are smoothened by being passed through the vision characteristics filter 33, and if the image that has passed through the vision characteristics filter 33 is magnified, then there will be no patterns that are offensive to the eye. Consequently, by magnifying the image selected by the selection portion 34 with the edge emphasizing image magnification portion 35, it is possible to obtain, as the magnification image of the original image, an image that has little image quality degradation. It should be noted that patterns or regions that have been judged to be easy to differentiate in the original image are processed by the edge emphasizing image magnification portion 35 without being passed through the vision characteristics filter 33, so that the magnification process can be performed while suppressing jaggedness or fuzziness of edges in the image.

1.4 Output Portion

The output portion 4 in this embodiment outputs, as the magnification image of the original image, the magnified image made of the images output from the magnification processing portion 3 configured as described above. For this, the output portion 4 outputs image data or image signals in a format that is adapted to the output destination of the image magnification portion of the present embodiment (display device or printer or the like).

1.5 Advantageous Effect

With the above-described embodiment, an image magnification is performed on the patterns or regions in the original image (constituent images or image portions) with a method in accordance with differentiability for humans, or an image magnification is performed in which edges are emphasized after regions with low differentiability have been smoothened. Thus, a magnification process is performed in which patterns that are difficult to differentiate and non-conspicuous with regard to the gradation characteristics of human vision stay non-conspicuous, whereas the edges of patterns that are easy to differentiate and conspicuous are emphasized. Consequently, while utilizing a conventional magnification method for improving the jaggedness or fuzziness of edges in an image, image patterns such as visually non-conspicuous noise or patterns that are included in the original image before magnification can be kept non-conspicuous after the magnification as well, and as a result, it is possible to prevent image deterioration that occurs when noise or patterns that are difficult to differentiate before the magnification are magnified.

1.6 Modified Example of First Embodiment

The first embodiment was based on the premise that all portions of the image magnification apparatus are realized by special hardware. However, it is also possible to realize some or all portions of the image magnification apparatus as software, by executing a predetermined program on a computer. For example, in the first embodiment, it is also possible to realize the magnification processing portion 3 by software. In this case, different from the configuration shown in FIG. 10, one of the two types of image magnification processes, namely spatial frequency preserving image magnification processing and edge emphasizing image magnification processing is selected in accordance with a result of judging the differentiability, and the selected image magnification process is executed, but the spatial frequency preserving image magnification processing and edge emphasizing image magnification processing are ordinarily not executed simultaneously. A case in which the image magnification apparatus is realized by software is discussed below in the fourth embodiment of the present invention.

In the first embodiment, the differentiability of patterns (constituent images (frequency components) or image portions (regions)) in the original image is judged based on the gradation characteristics of human vision, but it is also possible to judge the differentiability in the original image based on other vision characteristics than this gradation characteristics.

Furthermore, in the first embodiment, as the judgment result for the differentiability in the original image, two kinds of judgment results were obtained, namely the judgment result that differentiability is high (easy to differentiate) and the judgment result that differentiability is low (difficult to differentiate), but it is also possible to obtain three or more judgment results regarding the differentiability by setting two or more thresholds, for example.

### 2. Second Embodiment

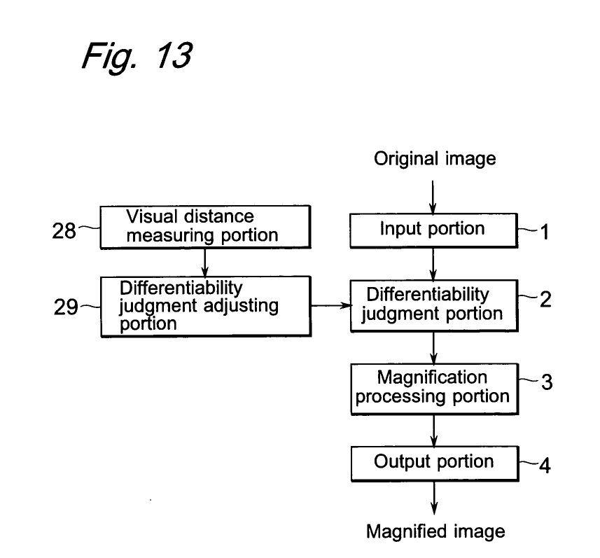

FIG. 13 is a block diagram illustrating the overall configuration of an image magnification apparatus in accordance with a second embodiment of the present invention. This image magnification apparatus is based on the premise that it is used in a display apparatus displaying the magnified image attained therewith, and a visual distance measuring portion 28 that measures the visual distance that is a distance from the display surface on which the magnified image is displayed to the point of observation at which a person views the magnified image, and a differentiability judgment adjusting portion 29 that adjusts the characteristics of this differentiability judgment portion in accordance with the measurement results have been added to the configuration of the image magnification apparatus according to the first embodiment as shown in FIG. 1. Other components and the detailed configuration of these other components elements in this embodiment are the same as in the first embodiment, (see FIGS. 1, 3, 9, 10, and 12), so that the same reference numerals have been given to the same portions and further descriptions have been omitted.

In the gradation characteristics of human vision, it is obvious that the differentiation capability of image patterns decreases with an increase in the visual distance, and it is also obvious that the differentiation capability of image patterns increases with a decrease in the visual distance. In this embodiment, the characteristics of the differentiability judgment portion 2, that is, the judgment criteria for differentiability, are adjusted with the differentiability judgment adjusting potion 29 such that if the visual distance as measured with the visual distance measuring portion 28 is long, there will be more regions that are judged to be difficult to differentiate (have low differentiability) in the original image, and if the measured visual distance is short, there will be fewer regions that are judged to be difficult to differentiate (have low differentiability) in the original image. To adjust the characteristics of the differentiability judgment portion 2 (the judgment criteria for differentiability), it is possible that, for example in the configuration shown in FIG. 3, the amplitude threshold Th and the frequency threshold ω_{T} are adjusted through the threshold adjusting portion 23, or in the configuration shown in FIG. 9, the filter characteristics of the filter 24 are adjusted through the filter adjusting portion 27.

With this configuration, the differentiability is adjusted in the same manner as the gradation characteristics of human vision, in accordance with the visual distance from the display surface on which the magnified image is to be displayed to the point of observation at which a person views the magnified image, so that a magnified image with little image quality degradation that corresponds to the present visual distance, can be attained.

### 3. Third Embodiment

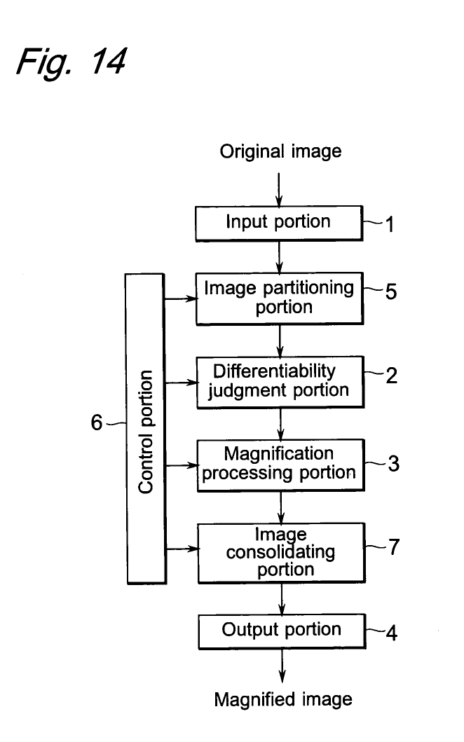

FIG. 14 is a block diagram illustrating the overall configuration of an image magnification apparatus in accordance with a third embodiment of the present invention. This image magnification apparatus is provided with an input portion 1, a differentiability judgment portion 2, a magnification processing portion 3 and an output portion 4 like the image magnification apparatus according to the first embodiment as shown in FIG. 1, and is further provided with an image partitioning portion 5, an image consolidating portion 7, and a control portion 6. The image partitioning portion 5 partitions the original image into partial images of N×N blocks. The image consolidating portion 7 consolidates magnified images of those partial images. And the control portion 6 controls the image partitioning portion 5, the differentiability judgment portion 2, the magnification processing portion 3 and the image consolidating portion 7.

The control portion 6 in this configuration causes the image partitioning portion 5 to partition the original image into N×N blocks (partial images), and after judging the differentiability of each of the blocks (partial images) with the differentiability judgment portion 2, it causes the magnification processing portion 3 to perform a magnification process in accordance with the result of this judgment, and causes the image consolidating portion 7 to consolidate the magnified partial images. The control portion 6 controls the repeated processing (the repeated differentiability judgment and magnification processing) for each of the blocks.

With the present embodiment, the data amount that is processed at one time is reduced by partitioning the original image to be magnified into N×N blocks, and sequentially performing a differentiability judgment process and an image magnification process for each block. Therefore, the amount of memory and circuitry necessary for image processing in this image magnification apparatus can be reduced. Furthermore, by performing the differentiability judgment process and the image magnification process for the N×N blocks in parallel, it is possible to shorten the processing time of the image magnification apparatus.

Furthermore, with this embodiment, as in the first embodiment, a magnification process in which patterns that are difficult to differentiate and non-conspicuous stay non-conspicuous is performed based on a judgment result for differentiability of image patterns in the original image in view of the gradation characteristics of human vision, whereas the edges of patterns that are easy to differentiate and conspicuous are emphasized. Thus, it is possible to prevent image deterioration that occurs when noise or patterns that are difficult to differentiate before the magnification are magnified.

It should be noted that in the present embodiment, the original image is partitioned into N×N blocks by the image partitioning portion 5, but the number of partitions in longitudinal direction (vertical direction) and lateral direction (horizontal direction) may differ. That is to say, a configuration is also possible in which the original image is partitioned into N×M blocks (with N≠M) by the image partitioning portion 5.

### 4. Fourth Embodiment

The following is a description of an image magnification apparatus according to a fourth embodiment of the present invention. This image magnification apparatus is a computer (for example a microcomputer on one chip) that, in terms of hardware, includes a CPU (central processing unit) and a memory, wherein functionality that is equivalent to the functionality of the image magnification apparatus according to the first embodiment is realized in software by executing with the CPU a predetermined image processing program (referred to as “image magnification processing program” in the following) stored in the memory. It should be noted that if an image to be displayed with a display device is generated by the image magnification apparatus of the present invention, then the magnified image must ordinarily be generated in real-time, but if an image to be output with a printer is generated by the image magnification apparatus of the present invention, then processing in real-time is no necessarily required. Consequently, in the latter case, it is possible to realize the image magnification apparatus by software based on the premise of a computer (micro-computer or the like) serving as hardware, as in the present embodiment.

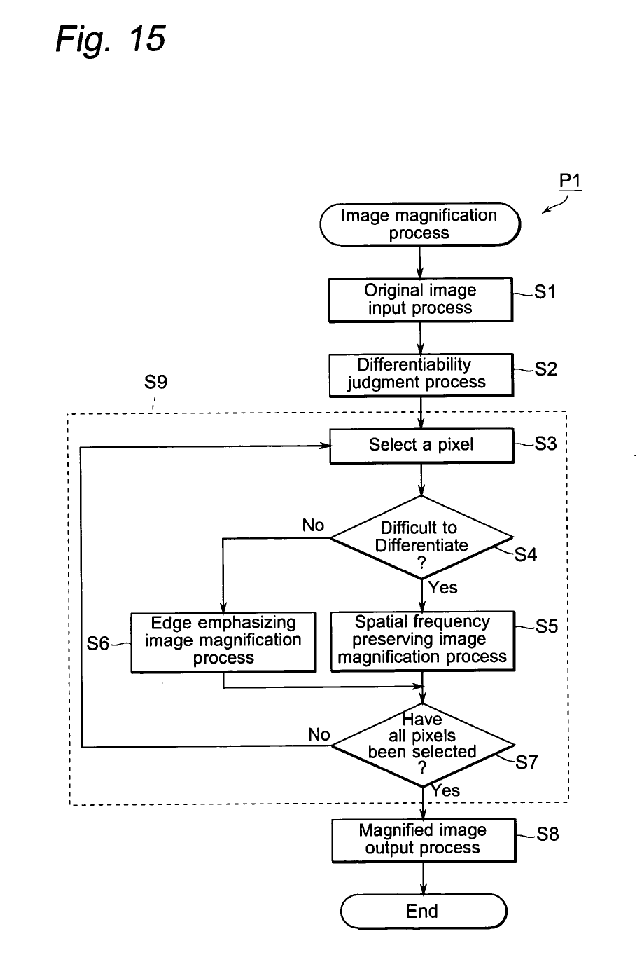

FIG. 15 is a flowchart showing the procedure performed by the image magnification apparatus according to the present embodiment, that is, the operation of a CPU based on the image magnification processing program P1. The CPU in this image magnification apparatus operates as follows, based on this image magnification processing program P1.

First, an original image input process is carried out (Step S1). In this original image input process, image data representing the original image that is input from the outside (in the following referred to as “input image data”) are stored in an input buffer that is provided inside a memory constituting the computer.

Then, a differentiability judgment process is performed on the input image data (Step S2). In this differentiability judgment process, regions in the original image indicated by the input image data are identified in which there are patterns that are difficult to differentiate (patterns with low differentiability) with regard to the vision characteristics (more specifically, the visual gradation characteristics), and flags indicating the presence of such regions are set. The configuration may be such that the number of flags is the same as the number of pixels of the original image and each flag corresponds to one pixel of the original image, but it is also possible to set coordinate values indicating regions that are difficult to differentiate in the original image as the values of the flags.

Then, the original image indicated by the input image data is subjected to a magnification process in correspondence to the differentiability based on human vision characteristics (Step S9). In this magnification process, the CPU operates as follow.

First, a pixel in the original image represented by the input image data is selected (Step S3). Then, by referencing the value of the flag corresponding to the selected pixel, it is determined whether the selected pixel is difficult to differentiate or not (whether its differentiability is low or not) (Step S4). If the result of this determination is that the selected pixel is located in a region of a pattern that is difficult to differentiate, then the selected pixel is subjected to a process in which it is magnified as difficult to differentiate, that is, to a spatial frequency preserving magnification process (more specifically, the selected pixel is subjected to a magnification process in which the values of the surrounding pixels of the selected pixels are also considered; see FIG. 11A), and the image data obtained with this magnification process are stored in an output buffer provided inside the memory (Step S5). On the other hand, if the result of the determination is that the selected pixel is not located in a region of a pattern that is difficult to differentiate, that is, if it is located in a region of a pattern that is easy to differentiate, then it is subjected to a magnification process that compensates edges, that is, an edge emphasizing image magnification process (more specifically, the selected pixel is subjected to a magnification process in which the values of the surrounding pixels of the selected pixels are also considered; see FIG. 11B), and the image data obtained with this magnification process are stored in the output buffer (Step S6). It should be noted that what is referred to here as edge compensation is a method in which the jaggedness or fuzziness of edges after the image magnification is reduced, as is the purpose of the conventional technology.

After the image magnification process of Step S5 or S6 has been performed, it is determined whether all of the pixels of the original image represented by the input image data have been selected (Step S7). If the result of this determination is that there are pixels in the original image that have not yet been selected, then the procedure returns to Step S3, another pixel is selected from the pixels that have not yet been selected, and the steps from Step S3 onward are performed again for this newly selected pixel. Then, the Steps S3 to S7 are repeated as long as there are pixels in the original image represented by the input image data that have not yet been selected, and when there are no more pixels in the original image that have not yet been selected, the procedure advances to Step S8.

When the procedure has advanced to Step S8, the data representing the magnified image of the original image indicated by the input image data are stored in the output buffer, and the data representing this magnified image are output in Step S8.

With the present embodiment as described above, as in the first embodiment, a magnification process in which patterns that are difficult to differentiate and non-conspicuous from the viewpoint of human vision characteristics (gradation characteristics of vision) stay non-conspicuous is performed, whereas the edges of patterns that are easy to differentiate are emphasized. Consequently, it is possible to ensure that image patterns, such as noise or patterns included in the original image before magnification that are visually non-conspicuous, are also non-conspicuous after the magnification, while utilizing a conventional magnification method that improves the jaggedness or fuzziness of edges in the image.

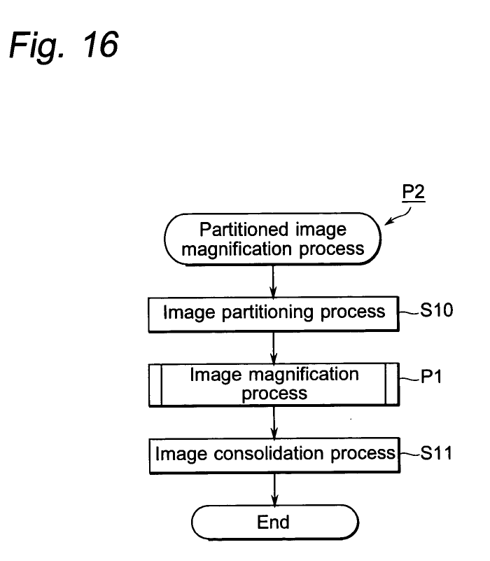

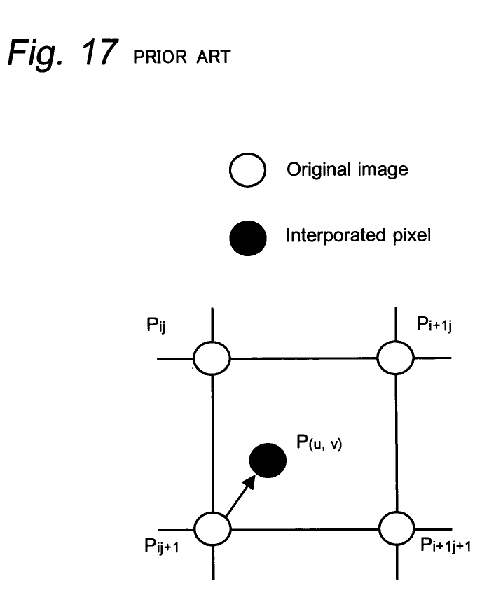

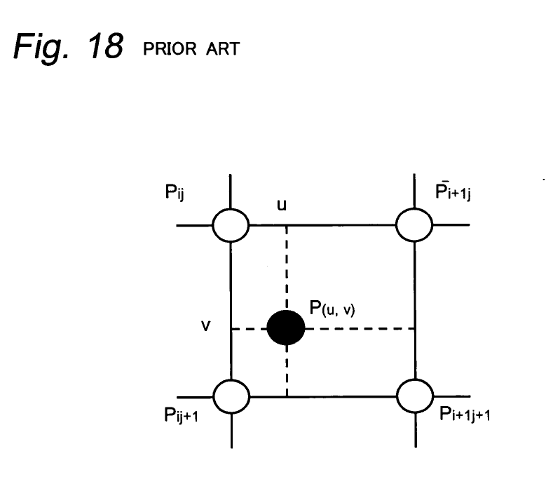

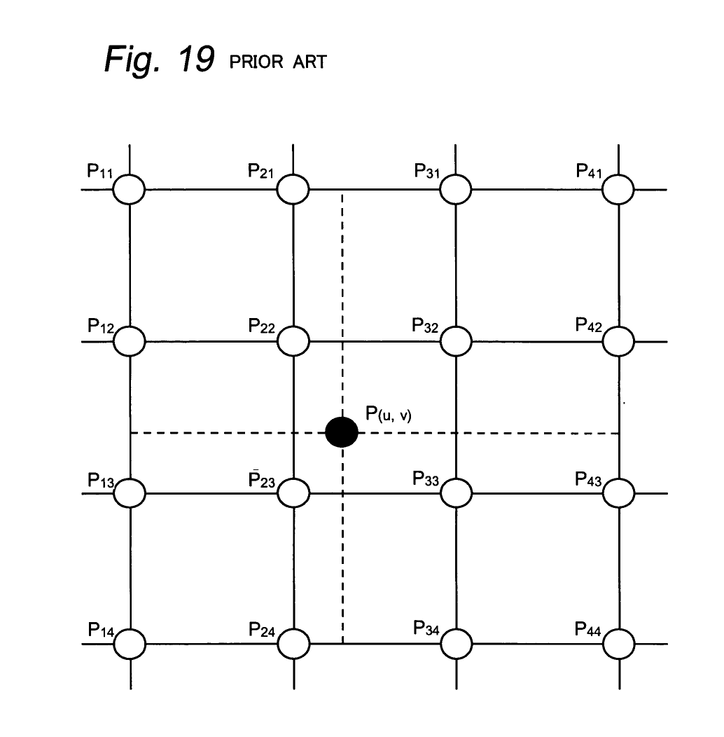

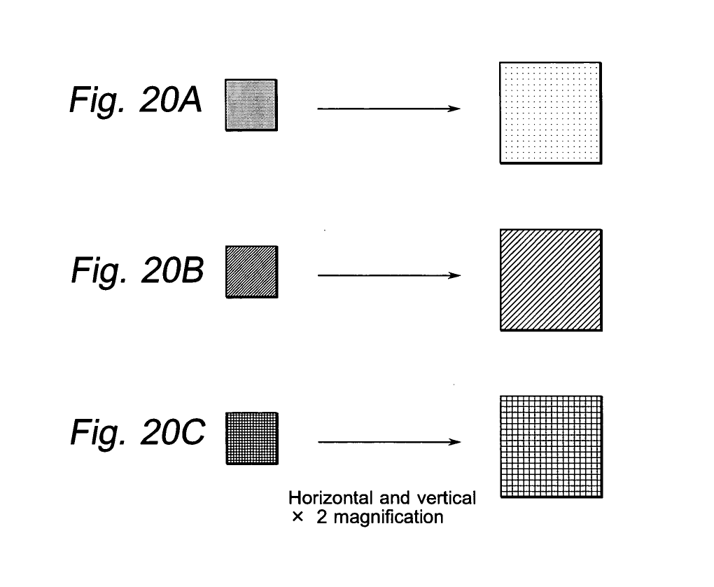

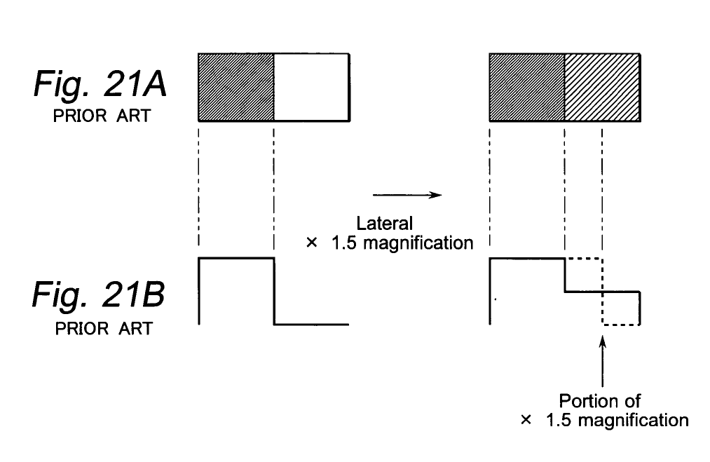

In the present embodiment, functionality that is equivalent to the functionality of the image magnification apparatus according to the first embodiment is realized in software, but it is also possible to realize functionality that is equivalent to the functionality of the image magnification apparatus according to the third embodiment (see FIG. 14) in software. In this case, a partitioned image magnification processing program as shown in FIG. 16 should be executed on a CPU, with the same hardware configuration as in the above-described embodiment. With this partitioned image magnification processing program, the CPU first partitions the original image to be magnified into N×N blocks (partial images) (Step S10). Then, taking the image data representing the partial images of the blocks as the input image data and executing the process according to the above-noted image magnification processing program P1 shown in FIG. 15, data representing the magnified images of the partial images are generated as magnified partial image data. Then, the image data representing the magnified image of the original image can be generated by consolidating the magnified partial image data (Step S11).

While the invention has been described in detail, the foregoing description is in all aspects illustrative and not restrictive. It is understood that numerous other modifications and variations can be devised without departing from the scope of the invention.

The present application claims priority upon Japanese Patent Application 2002-296072 titled “IMAGE PROCESSING APPARATUS, IMAGE PROCESSING METHOD AND IMAGE PROCESSING PROGRAM FOR MAGNIFYING AN IMAGE,” filed on Oct. 9, 2002, the content of which is hereby incorporated by reference.

What is claimed is:

1. An image processing apparatus for magnifying an image, comprising:
a differentiability judgment portion for judging differentiability in an original image to be magnified, based on human vision characteristics; and
a magnification processing portion for generating a magnified image of the original image by magnifying the original image in a manner that is adapted to the differentiability judged by the differentiability judgment portion.

2. The image processing apparatus according to claim 1, wherein the differentiability judgment portion judges the differentiability based on gradation characteristics of human vision.

3. The image processing apparatus according to claim 1, wherein the differentiability judgment portion comprises:
a decomposing portion for decomposing the original image into a plurality of constituent images, based on spatial frequency; and
a threshold processing portion for determining the differentiability of each of the constituent images by classifying the plurality of constituent images with a predetermined threshold value based on human vision characteristics;
wherein the magnification processing portion magnifies the constituent images obtained with the decomposing portion in a manner that is adapted to the differentiability determined by the threshold processing portion for each of the constituent images, and generates a magnified image of the original image by combining the magnified constituent images.

4. The image processing apparatus according to claim 3, further comprising an adjusting portion for adjusting the predetermined threshold.

5. The image processing apparatus according to claim 1, wherein the differentiability judgment portion comprises:
a filter portion having filter characteristics approximating human vision characteristics;
a differential generating portion for generating a differential between the original image and the image obtained by passing the original image through the filter portion; and
a differentiability determining portion for determining the differentiability in the original image based on the differential.

6. The image processing apparatus according to claim 5, further comprising an adjusting portion for adjusting the filter characteristics of the filter portion.

7. The image processing apparatus according to claim 1, wherein the magnification processing portion comprises:
a plurality of image magnification portions for performing different types of image magnification processes on the original image; and
a selection portion for selecting from the plurality of image magnification portions the image magnification portion that is to generate the magnified image of the original image in accordance with the differentiability judged by the differentiability judgment portion.

8. The image processing apparatus according to claim 7,
wherein the differentiability judgment portion judges whether the differentiability in the original image is high or low;
wherein the magnification processing portion comprises, as the plurality of image magnification portions, a first image magnification portion for magnifying the original image while preserving a spatial frequency of the original image, and a second image magnification portion for magnifying the original image while emphasizing edges of the original image; and
wherein the selection portion selects the first image magnification portion if the differentiability has been judged to be low by the differentiability judgment portion, and selects the second image magnification portion if the differentiability has been judged to be high by the differentiability judgment portion.

9. The image processing apparatus according to claim 1,
wherein the differentiability judgment portion judges whether the differentiability in the original image is high or low; and
wherein, if the differentiability has been judged to be low by the differentiability judgment portion, the magnification processing portion carries out the image magnification process after a filtering process with filter characteristics approximating human vision characteristics has been performed.

10. The image processing apparatus according to claim 9, wherein the magnification processing portion comprises:
a filter portion that has filter characteristics approximating human vision characteristics and through which the original image is passed;
a selection portion for selecting from the image obtained by passing the original image through the filter portion, an image portion corresponding to an image portion of the original image whose differentiability has been judged to be low, if the differentiability has been judged to be low by the differentiability judgment portion, and for selecting from the original image, an image portion whose differentiability has been judged to be high, if the differentiability has been judged to be high by the differentiability judgment portion; and
an image magnification portion for magnifying, while emphasizing edges, an image made of the image portions selected by the selection portion.

11. The image processing apparatus according to claim 1, further comprising:
a measuring portion for measuring a visual distance from a display surface on which the magnified image obtained by magnifying the original image with the magnification processing portion is to be displayed to a viewpoint of a person that is to view the magnified image; and
an adjusting portion for adjusting a judgment criterion of the differentiability in the differentiability judgment portion based on the visual distance.

12. The image processing apparatus according to claim 1, further comprising:
a partitioning portion for partitioning the original image into a plurality of partial images; and
a control portion for causing the differentiability judgment portion to judge the differentiability of each of the partial images obtained with the partitioning portion, based on human vision characteristics, and for causing the magnification processing portion to magnify the partial images in a manner that is adapted to their respective judged differentiability.

13. An image processing method for magnifying an image, comprising:
a differentiability judgment step of judging differentiability in an original image to be magnified, based on human vision characteristics; and
a magnification processing step of generating a magnified image of the original image by magnifying the original image in a manner that is adapted to the differentiability judged based on the human vision characteristics.

14. The image processing method according to claim 13, wherein in the differentiability judgment step, the differentiability is judged based on gradation characteristics of human vision.

15. The image processing method according to claim 13, wherein the differentiability judgment step comprises:
a decomposition step of decomposing the original image into a plurality of constituent images, based on spatial frequency; and
a threshold processing step of determining the differentiability of each of the constituent images by classifying the plurality of constituent images with a predetermined threshold value based on human vision characteristics;
wherein in the magnification processing step, the constituent images obtained in the decomposition step are magnified in a manner that is adapted to the differentiability determined by the threshold processing step for each of the constituent images, and a magnified image of the original image is generated by combining the magnified constituent images.

16. The image processing method according to claim 13, wherein the differentiability judgment step comprises:
a differential generation step of generating a differential between the original image and the image obtained by passing the original image through a filter having filter characteristics that approximate human vision characteristics; and
a differentiability determination step of determining the differentiability in the original image based on the differential.

17. The image processing method according to claim 13, wherein the magnification processing step comprises:
a selection step of selecting an image magnification process from different types of image magnification processes that have been prepared in advance, in accordance with the differentiability judged with the differentiability judgment step; and
an image magnification step of magnifying the original image with the selected image magnification process.

18. The image processing method according to claim 13,
wherein in the differentiability judgment step, it is judged whether the differentiability in the original image is high or low; and
wherein, if the differentiability has been judged to be low in the differentiability judgment step, the image magnification process is carried out in the magnification processing step after a filtering process with filter characteristics approximating human vision characteristics has been performed.

19. The image processing method according to claim 13, further comprising:
a measurement step of measuring a visual distance from a display surface on which the magnified image obtained by magnifying the original image in the magnification processing step is to be displayed to a viewpoint of a person that is to view the magnified image; and
an adjustment step of adjusting a judgment criterion of the differentiability in the differentiability judgment step based on the visual distance.

20. The image processing method according to claim 13, further comprising:
a partition step of partitioning the original image into a plurality of partial images;
wherein in the differentiability judgment step, the differentiability of each of the partial images obtained with the partition step is judged based on human vision characteristics; and
wherein in the magnification processing step, the partial images are magnified in a manner that is adapted to their respective judged differentiability.

21. An image processing program for magnifying an image, the program, when executed by a computer, causing the computer to perform:
a differentiability judgment step of judging differentiability in an original image to be magnified, based on human vision characteristics; and
a magnification processing step of generating a magnified image of the original image by magnifying the original image in a manner that is adapted to the differentiability judged based on the human vision characteristics.

22. The image processing program according to claim 21, wherein in the differentiability judgment step, the differentiability is judged based on gradation characteristics of human vision.

23. The image processing program according to claim 21, wherein the differentiability judgment step comprises:
a decomposition step of decomposing the original image into a plurality of constituent images, based on spatial frequency; and
a threshold processing step of determining the differentiability of each of the constituent images by classifying the plurality of constituent images with a predetermined threshold value based on human vision characteristics;
wherein in the magnification processing step, the constituent images obtained in the decomposition step are magnified in a manner that is adapted to the differentiability determined by the threshold processing step for each of the constituent images, and a magnified image of the original image is generated by combining the magnified constituent images.

24. The image processing program according to claim 21, wherein the differentiability judgment step comprises:
a differential generation step of generating a differential between the original image and the image obtained by passing the original image through a filter having filter characteristics that approximate human vision characteristics; and
a differentiability determination step of determining the differentiability in the original image based on the differential.

25. The image processing program according to claim 21, wherein the magnification processing step comprises:
a selection step of selecting an image magnification process from different types of image magnification processes that have been prepared in advance, in accordance with the differentiability judged with the differentiability judgment step; and
an image magnification step of magnifying the original image with the selected image magnification process.

26. The image processing program according to claim 21,
wherein in the differentiability judgment step, it is judged whether the differentiability in the original image is high or low; and
wherein, if the differentiability has been judged to be low in the differentiability judgment step, the image magnification process is carried out in the magnification processing step after a filtering process with filter characteristics approximating human vision characteristics has been performed.

27. The image processing program according to claim 21, further comprising:
a measurement step of measuring a visual distance from a display surface on which the magnified image obtained by magnifying the original image in the magnification processing step is to be displayed to a viewpoint of a person that is to view the magnified image; and
an adjustment step of adjusting a judgment criterion of the differentiability in the differentiability judgment step based on the visual distance.

28. The image processing program according to claim 21, further comprising:
a partition step of partitioning the original image into a plurality of partial images;
wherein in the differentiability judgment step, the differentiability of each of the partial images obtained with the partition step is judged based on human vision characteristics; and
wherein in the magnification processing step, the partial images are magnified in a manner that is adapted to their respective judged differentiability.
